(19) United States
(12) Patent Application Publication
(10) Pub. No.: US 2008/0147247 A1
(43) Pub. Date: Jun. 19, 2008

(54) Circuit for controlling an acceleration, braking and steering system of a vehicle

(76) Inventor: Anton Weldin, Leinfelden-Echterdingen (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/656,109

(22) Filed: Jan. 22, 2007

(30) Foreign Application Priority Data
Dec. 18, 2006 (DE) DE 102006060093.2
Dec. 27, 2006 (DE) DE 102006062300.2

(51) Int. Cl. G06F 17/00

(52) U.S. Cl. 701/1

(57) ABSTRACT

A circuit for controlling an acceleration, braking and steering system of a vehicle with at least two separate motors (13, 14) for actuating the acceleration and braking system and at least two separate motors (11, 12) for actuating the steering system, with at least one electronic control unit (17) for controlling the at least two separate motors (13, 14) for actuating the acceleration and braking system and at least one electronic control unit (16) for controlling the at least two separate motors (11, 12) for actuating the steering system, wherein all the control units (16, 17) are connected via separate lines (20, 21, 22, 23) to a voltage supply (18, 19).

The invention relates to a circuit for controlling an acceleration, braking and steering system of a vehicle with at least two separate motors for actuating the acceleration and braking system and at least two separate motors for actuating the steering system and at least one electronic control unit for controlling the at least two separate motors for actuating the acceleration and braking system and at least one electronic control unit for controlling the at least two separate motors for actuating the steering system.

Steering systems with in each case two separate motors for controlling the acceleration and braking system and for actuating the steering system are already known from the applicant's German patent application DE 10 2004 051 078 A1. Furthermore, there is known in the trade under the designation AEVIT an acceleration, braking and steering system, wherein motors with two windings are provided in each case for controlling the braking and acceleration system and the steering system, wherein the two windings are however brought together on the collector, i.e. act electrically as one winding. There is therefore no redundancy with the motors. In the AEVIT system, two separate control units are provided for controlling the motors, the voltage supply of one of the control units being fed via the other control unit. There is the great drawback that, in the event of failure of the control unit via which the supply voltage to the second control unit is fed, the second control unit also fails. In other words, this can lead to a situation where, when the control unit for the steering system fails, braking or acceleration of the vehicle is no longer possible either or, if the control unit for the acceleration and braking system fails, the steering also fails.

There is known from U.S. Pat. No. 5,086,870 a control system for a vehicle, which has a device for the steering and for the acceleration and braking. With this control system, however, only one motor is present in each case as the drive for the acceleration and braking system and for the steering system, i.e. with this system too, there is no redundancy in respect of the drive motors for the steering and for the acceleration and braking system.

The problem underlying the present invention is to provide a circuit for controlling the known steering systems, which exhibits greater reliability against failure of the braking and acceleration system and the steering system.

The problem is solved with a circuit for controlling an acceleration, braking and steering system of a vehicle, which comprises at least two separate motors for actuating the acceleration and braking system and at least two separate motors for actuating the steering system as well as at least one electronic control unit for controlling the at least two separate motors for actuating the acceleration and braking system and at least one electronic control unit for controlling the at least two separate motors for actuating the steering system, and which is characterised in that all the control units are connected via separate lines to at least one voltage supply.

In the circuit according to the invention, if there is a failure of a control unit for one of the two systems—braking and acceleration or steering—or if there is an interruption of the conductor routing to this control unit, the system not controlled at the time by the failed control unit does not at the same time also come to a standstill. That is to say that, if for example the acceleration and braking system fails on account of defects in the respective control unit or in the voltage supply lines, the driver can at least still steer the vehicle. Conversely, the brakes can still be applied to the vehicle if the steering system fails. The separate voltage supply of all the control units for the two separate systems as provided for according to the invention therefore leads to a considerable increase in safety for the driver of the vehicle. The circuit according to the invention and the acceleration, braking and steering system can be used for the most varied vehicles on land, in the air and on water. A high degree of reliability of all the components, especially the control circuit, is imperative especially in the case of vehicles for the handicapped and on aircraft.

In a preferred embodiment, the circuit according to the invention can have in each case a control unit with in each case two identical CPU channels with in each case two CPUs for controlling the in each case at least two separate motors for actuating the acceleration and braking system and the steering system, the second CPU channels in each case taking over the function of the first CPU channels if the first CPU channels fail, and/or the second CPU in each case taking over the function of the first CPU if the latter fails. The CPU channels represent in each case complete control units which can be used alternately without any loss of function. As a result of the provision of redundant CPUs, a measure which is known per se, the reliability of the control can be further increased. With this embodiment, moreover, a safety processor or logic unit can preferably be provided, which monitors the function of the first CPU channels and/or the first CPUs and, in the event of a malfunction of one of the first CPU channels and/or first CPUs, deactivates the latter and instead activates the respective second channel and/or the respective second CPU. A dual control is therefore provided for each of the systems—acceleration and braking as well as steering, wherein one of the control circuits is activated solely in the event of failure of the other and wherein a central safety processor assumes the functional control of the channels and/or the CPUs and determines which of the channels or the CPUs is currently being used for the control.

A further measure for increasing the reliability against failure of the control circuit lies in the fact that two voltage supplies are provided and all the control units are connected via separates lines to the two voltage supplies. Failure of the voltage supply can therefore also be reliably guarded against and the inventive independence of all the control units from the function of the other control units can be maintained.

Apart from or as an alternative to the increase in the reliability against failure of the control circuit by the provision of separate connections of the control units to the voltage supply, the control circuit is also able to guarantee a greater reliability against failure of the acceleration, braking and steering system of the vehicle by the fact that it has current measuring devices which measure separately the flow of current through each of the at least two separate motors for actuating the acceleration and braking system and the steering system. With the known AEVIT system for the acceleration, braking and steering of a vehicle, a separate current measurement of the two windings for the acceleration and braking system and for the steering system does not take place for design reasons. The two windings of the motors are brought together on a collector. The current measurement takes place before the collector, i.e. jointly for both windings. If a short-circuit is ascertained during the current measurement in the case of the known system, it is not possible to analyse which of the two windings has a short-circuit. It is not therefore possible to deactivate one of the motor windings selectively and to continue to operate the other. The known system lacks the corresponding hardware requirements and devices in the control system to do this. If a winding fails, the drive of the acceleration and braking system and of the steering system continues with only half the power, half the force and half the speed. When the still functioning motor comes to a standstill, it may possibly not be able to be started again, since the brushes of the still functioning winding stand at 180° opposite one another and the initial dead centre cannot therefore be overcome.

If, on the other hand, two motors are provided that are also actually separated from one another electrically and if the current measurement for the two motors takes place separately, no reduction in the force at the end point of the motion occurs in the event of a short-circuit of one of the motors. The still functioning motor completely takes over the task that the two motors have previously performed jointly and delivered via a common gear unit to the acceleration and braking system and the steering system.

It is also advantageous if the circuit has relays for activating and deactivating each of the motors for actuating the acceleration and braking system and the steering system. Each of the motors can thus be switched on or off in a selective manner.

In order to guarantee a rapid response of the acceleration, braking and steering system of the vehicle and thus in particular to enable direct and play-free steering, use may be made of high dynamic servomotors with a low inductivity, which require high current strengths, preferably 36 A, for the drive. When these motors are used, it is advantageous if the circuit has choke coils for controlling the motors for actuating the acceleration and braking system and the steering system.

Further advantages regarding a greater reliability against failure of the circuit can be achieved if the control and triggering part of the circuit is arranged in an interference-decoupled manner from the power part of the circuit. For this purpose, the circuit can be arranged for example on at least one board with eight wiring planes. The individual wiring planes are well insulated from one another and shielded in terms of EMC, so that wiring levels other than those for the power part can be used for the control and triggering part.

The electronic control units, too, can be designed specially for safety against interfering radiation, EMC (electromagnetic compatibility) and energy-saving and thus cool power supply of the redundant electronics, in order to minimise the susceptibility to faults and the thermal loads on the system.

It goes without saying that a control of only one of the systems—acceleration and braking system or steering system—can be provided and the respective other function is performed by the standard drive devices provided in the vehicle. In the case of conversion of vehicles for the handicapped, it is often sufficient—depending on the nature of the handicap—to make either only the steering or the accelerating and braking system operable by means of joysticks or suchlike, whilst the other functions can continue to be activated by the accelerator and brake pedal or by means of the unchanged steering wheel. In this case, two redundant motors have to be provided solely for one of the systems, said motors being controlled via a control unit with two identical CPU channels. The CPU channels can have two identical CPUs and thus complete redundant controls and monitoring devices for the two motors. All the features and advantages that have been described in connection with the control of the two systems—acceleration and braking system and steering system—also apply if the circuit contains the control of only one of the systems.

The invention also relates to a method for controlling an acceleration and braking system and a steering system of a vehicle with at least two separate motors for actuating the acceleration and braking system and at least two separate motors for actuating the steering system, wherein signals from operating elements in the vehicle for the acceleration and braking system are received and evaluated by at least one electronic control unit and the at least two separate motors of the acceleration and braking system are correspondingly controlled and signals from operating elements in the vehicle for the steering system are received and evaluated by at least one further electronic control unit and the at least two separate motors of the steering system are controlled, said method being characterised in that the voltage supply of each control unit is fed separately, the voltage supply of each control unit is monitored separately and a switch-over to a second voltage supply takes place in the event of failure of a voltage supply.

The monitoring of the voltage supply can be carried out through CPUs in the control unit, by means of a safety processor or a logic unit.

Further advantages regarding the redundancy and thus the reliability against failure arise if, for the control of the at least two separate motors of the braking and acceleration system and the steering system, in each case two identical CPU channels with in each case two CPUs are provided, the function of the first channels and/or the first CPUs is monitored and, in the event of malfunctions of the first channels and/or the first CPUs, the further control of the motors of the braking and acceleration system and/or of the steering system is switched over to the second channels and/or second CPUs. The monitoring of the function of the first channels and/or CPUs and the switch-over to the second channels and/or CPUs can also be carried out by the safety processor or a logic unit.

Further advantages of the method according to the invention can be achieved by the fact that the current flow through each of the at least two separate motors of the acceleration and braking system and of the steering system is measured and, if a short-circuit is ascertained in one of the motors, the latter is switched off. The motive power for the braking and acceleration system and the steering system continues to be fully maintained by the respective other, still functioning motor. Only the speed is reduced. By means of the separate current measurement for each of the motors, it is also possible to establish precisely which motor has actually failed, so that the latter can be switched off in a selective manner.

A preferred example of embodiment of a circuit according to the invention will be described in greater detail below with the aid of the drawing.

In the figures:

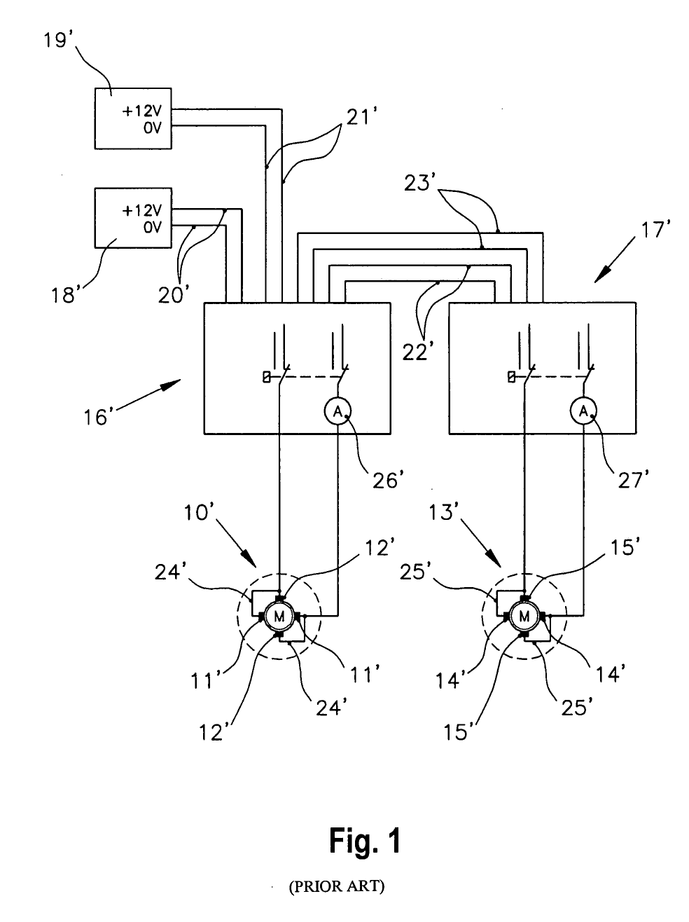

FIG. 1 shows a basic block diagram of a control circuit according to the prior art;

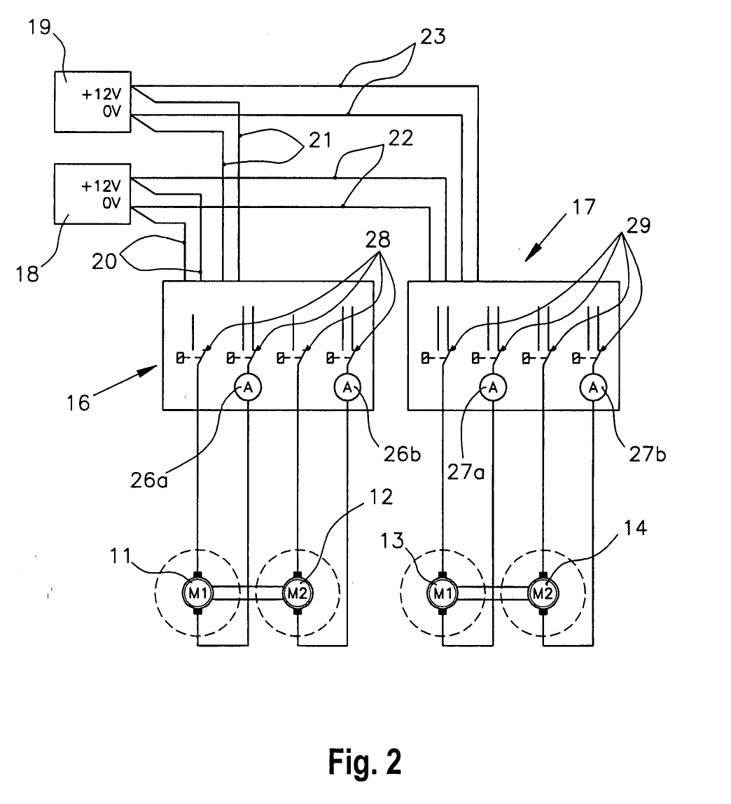

FIG. 2 shows a basic block diagram of a control circuit according to the invention;

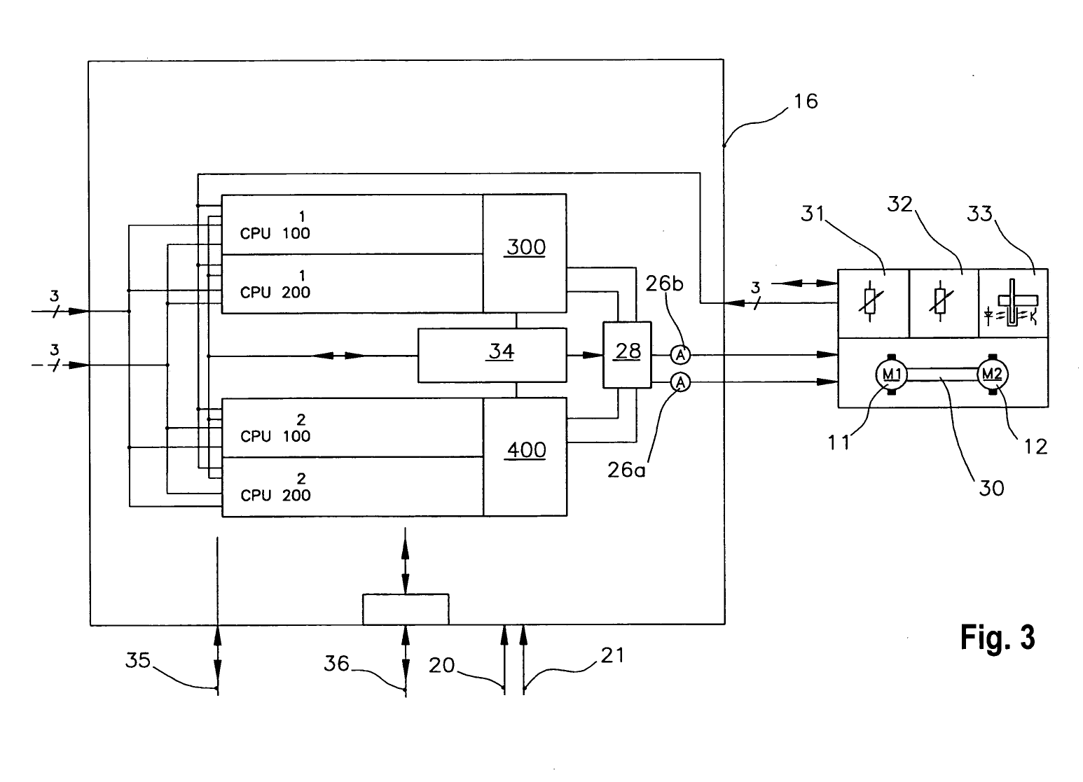

FIG. 3 shows a block diagram of a control unit of the control circuit from FIG. 2.

FIG. 1 shows, as a block diagram, the control circuit for the AEVIT acceleration, braking and steering system available in the trade. A motor 10′ is represented from the acceleration and braking system, said motor having two windings, as a result of which four brushes 11′ and 12′ are present, brushes 11′, 12′ lying opposite a winding in each case at 180°. In a similar manner, the acceleration and braking system is also driven by a motor 13′ with two windings, this being indicated by the four brushes 14′ and 15′. Two control units 16′, 17′ are represented from the actual control circuit, unit 16′ being responsible for the steering and unit 17′ for the acceleration and braking system. Each of control units 16′, 17′ contains CPUs which are not explicitly represented here, i.e. each unit 16′, 17′ at least two identical CPUs. A main voltage supply 18′ and a stand-by voltage supply 19′ are also represented from the circuit. As FIG. 1 clearly shows, only control unit 16′ is supplied directly from voltage supplies 18′ and 19′. Supply lines 20′ and 21′ are respectively provided for this purpose. Control unit 17′ receives its voltage supply via control unit 16′ via supply lines 22′ and 23′. This means that, in the event of a failure of control unit 16′ and in particularly the voltage supply of the CPUs there, control unit 17′ is also no longer supplied with voltage, i.e. it also fails. In such a case, therefore, both the acceleration and braking system and the steering system simultaneously no longer function. The vehicle becomes completely incapable of being maneuvered.

A further drawback with the known circuit lies in the fact that both windings of motors 10′ and 13′ are wired together in such a way that they are completely dependent upon one another. This is indicated by connection lines 24′, 25′ between brushes 11′ and 12′ and respectively 14′, 15′. In the known circuit, therefore, only the current that flows through both windings of motors 10′, 13′ is measured in each case by means of a current measuring device 26′, 27′ in control units 16′, 17′. In the event of a short-circuit, therefore, it cannot be established which of the windings has failed. Since control units 16′, 17′ do not have any possibility, for design reasons, of dealing with this case, this operational state leads to a total failure of the steering system and the acceleration and braking system.

As FIG. 2 shows, however, the circuit according to the invention has the possibility of controlling two actually separate motors 11, 12 for the steering system and 13, 14 for the acceleration and braking system. Motors 11, 12 and 13, 14 are in each case connected in parallel with one another and respectively drive a common shaft of the respective system. The circuit according to the invention also has two control units 16, 17 for the steering system on the one hand and the acceleration and braking system on the other hand. Control units 16, 17 are also provided here with two identical redundant CPUs, which can be seen from FIG. 3. Unlike control units 16′, 17′ of the circuit according to the prior art, control units 16, 17 and thus also the CPUs contained in them are connected here via separate supply lines 20, 21 and respectively 22, 23 to main voltage supply 18 and a stand-by voltage supply 19. If a malfunction occurs in one of control units 16, 17 or in the voltage supply of these units, the respective other control unit 16, 17 continues to remain ready for operation. In each case, therefore, at most one of the systems “acceleration and braking” or “steering” can fail. The vehicle can then therefore either still be steered or still have the brakes applied, as a result of which the risk of accident is reduced considerably.

Furthermore, control units 16, 17 of the circuit according to the invention have separate current measuring devices 26a, b and 27a, b for motors 11, 12 and 13, 14. It is therefore possible to analyse precisely which of motors 11, 12 and respectively 13, 14 has failed. This motor can then be switched off via relays 28, 29. The other remains active and takes over the drive function alone.

FIG. 3 illustrates the internal structure of control unit 16 from FIG. 2 for controlling motors 11, 12 for the acceleration and braking system. Control unit 17 is constructed analogously.

In the example represented, there are two channels 1 and 2 provided, which each have two identical CPUs 100, 200. Assigned to each channel is a unit 300, 400, which monitor the voltage, the temperature and the current flow through motors 11, 12 and at the same time are output drivers for motors 11, 12. Units 300, 400 are constructed identically. The motion of motors 11, 12, or of common shaft 30 driven by them, is detected by two potentiometers 31, 32 as well as a digital encoder 33 and evaluated by CPUs 100, 200. During operation, only one of channels 1, 2 is active at a time. If a malfunction in the currently active channel is ascertained by a safety processor or a logic unit 34, which malfunction can be in CPUs 100, 200, in the input devices or in units 300, 400, there is a switch-over to the parallel other channel which takes over further control.

Control unit 16 also has two triple-channel inputs, wherein one of the inputs is intended for signals of a second control device, for example a remote control or a control device operated by a second driver, who may in particular be a driving instructor. The other input feeds signals from operating elements for the acceleration and braking system. Also drawn in FIG. 3 are connection lines 20, 21 to voltage supplies 18, 19 (FIG. 2) and connection lines 35, 36 to two separate CAN-bus systems. Functions such as WLAN controllers with ambient sensors, driving camera data, GPS positioning data and control commands can be conducted via the dual-channel redundant CAN-bus system.

1. A circuit for controlling an acceleration, braking and steering system of a vehicle with at least two separate motors (13, 14) for actuating the acceleration and braking system and at least two separate motors (11, 12) for actuating the steering system, with at least one electronic control unit (17) for controlling the at least two separate motors (13, 14) for actuating the acceleration and braking system and at least one electronic control unit (16) for controlling the at least two separate motors (11, 12) for actuating the steering system, characterized in that all the control units (16, 17) are connected via separate lines (20, 22) to at least one voltage supply (18, 19).

2. The circuit according to claim 1, characterized in that in each case two identical CPU channels within each case to CPUs are provided for controlling the in each case at least two separate motors (13, 14; 11, 12) for actuating the acceleration and braking system and the steering system, the second CPU channels in each case taking over the function of the first CPU channels if the first CPU channels fail, and/or the second CPUs in each case taking over the function of the first CPUs if the first CPUs fail.

3. The circuit according to claim 2, characterized in that a safety processor or logic unit is provided, which monitors the function of the first CPU channels and/or the first CPUs and, in the event of malfunctions of the first CPU channels and/or the first CPUs, deactivates the first CPU channel and/or the first CPU and activates the respective second channel and/or the respective second CPU.

4. The circuit according to claim 1, characterized in that at least one stand-by voltage supply (18, 19) is provided and all the control units (16, 17) are connected to all the voltage supplies (18, 19) via separate lines (20, 21, 22, 23).

5. The circuit according to claim 1, characterized in that it has current measuring devices (26a, b; 27a, b) which measure separately the flow of current through each of the at least two separate motors (11, 12; 13, 14) for actuating the acceleration and braking system and the steering system.

6. The circuit according to claim 1 characterized in that it has relays (28, 29) for activating and deactivating each of the motors (11, 12; 13, 14) for actuating the acceleration and braking system and the steering system.

7. The circuit according to claim 1, characterized in that the triggering and control part of the circuit is arranged in an interference-decoupled manner from the power part of the circuit.

8. The circuit according to claim 1, characterized in that it has choke coils for controlling high dynamic servomotors (11, 12, 13, 14) for actuating the acceleration and braking system and the steering system.

9. The circuit according to claim 1, characterized in that it is arranged on at least one board with eight wiring planes.

10. The circuit according to claim 1, characterized in that the control units (16, 17) have in each case two triple-channel inputs, whereof one has signals from operating elements of the acceleration and braking system or the steering system and the other input has signals of a second control device, in particular a remote control or a control device operable, actuatable by a passenger or driving instructor.

11. The circuit according to claim 1, characterized in that it has connections (35, 36) to two separate dual-channel CAN-bus systems.

12. A method for controlling an acceleration and braking system and a steering system of a vehicle with at least two separate motors (13, 14) for actuating the acceleration and braking system and at least two separate motors (11, 12) for actuating the steering system, wherein signals from operating elements in the vehicle for the acceleration and braking system are received and evaluated by at least one electronic control unit (17) and the at least two separate motors (13, 14) of the acceleration and braking system are correspondingly controlled and signals from operating elements in the vehicle for the steering system are received and evaluated by at least one further electronic control unit (16) and the at least two separate motors (11, 12) of the steering system are correspondingly controlled, characterized in that the voltage supply of each of the control units (16, 17) is fed separately and the voltage supply of the control units (16, 17) is monitored and a switch-over to a second voltage supply (18, 19) takes place in the event of failure of a voltage supply (18, 19).

13. The method according to claim 12, characterized in that the monitoring of the voltage supply (18, 19) is carried out through CPUs of the control units (16, 17), by means of a safety processor or a logic unit (34).

14. The method according to claim 12, characterized in that two identical CPU channels within each case to identical CPUs are provided in each case for controlling at least two separate motors (13, 14) of the acceleration and braking system and the steering system, the function of the first CPU channels and/or the first CPUs is monitored and, in the event of malfunctions of the first channels and/or CPU, further control of the motors of the acceleration and braking system and/or the steering system is switched over the second channels and/or second CPUs.

15. The method according to claim 12 characterized in that the flow of current through each of the at least two separate motors (11, 12, 13, 14) of the acceleration and braking system and the steering system is measured and, if a short-circuit is ascertained in a motor (11, 12, 13, 14), the latter is switched off.
